(19) United States
(12) Patent Application Publication
(10) Pub. No.: US 2008/0177556 A1
(43) Pub. Date: Jul. 24, 2008

(54) Business object status management

(76) Inventor: Long Fung Cheng, Fremont, CA (US)

Correspondence Address: HOLLAND & KNIGHT LLP, 10 ST. JAMES AVENUE, 11th Floor, BOSTON, MA, 02116-3889, US

(21) Appl. No.: 11/655,304

(22) Filed: Jan. 19, 2007

(51) Int. Cl. G06Q 10/00; G06F 17/00

(52) U.S. Cl. 705/1; 715/236; 715/234

(57) ABSTRACT

Methods and apparatus, including computer program products, for a business object status management. A computer-implemented method includes generating a state diagram using an Extensible Markup Language Schema Definition (XSD) file to represent a business object life cycle.

### BACKGROUND

The present invention relates to data processing by digital computer, and more particularly to business object status management.

Business objects are objects in an object-oriented computer program that abstract the entities in the domain that the program is written to represent. For example, an order entry program needs to work with concepts such as orders, line items, invoices and so on. Each of these may be represented by a business object.

Business objects are sometimes called domain objects (where the word domain means the business), and a domain model represents the set of domain objects and the relationships between them.

Good business objects typically encapsulate all of the data and behavior associated with the entity that it represents. For example, an order object will have the sole responsibility for loading an order from a database, exposing or modifying any data associated with that order (i.e., order number, the order's customer account), and saving the order back to the database.

Business objects don't necessarily need to represent objects in an actual business, though they often do. They can represent any object related to the domain in which a developer is creating business logic for. The term is used to distinguish between the objects a developer is creating or using related to the domain and all the other types of object he or she may be working with such as user interface widgets and database objects such as tables or rows.

### SUMMARY

The present invention provides methods and apparatus, including computer program products, for business object status management.

In general, in one aspect, the invention features a computer-implemented method including generating a state diagram using an Extensible Markup Language Schema Definition (XSD) file to represent a business object life cycle.

In embodiments, the XSD file can represent an XML schema instance. The XML schema can be a description of a type of XML document expressed in terms of constraints on a structure and content of documents of that type.

The method can include interfacing implementation application programming interfaces (APIs) to describe a business state for every stage in the life cycle.

In embodiments, the life cycle can include a status describing a business object state, a status set representing a collection of statuses and linked to processing rules to describe business process flow, an event representing a distinct business activity applied to a business object, and an event set representing a collection of events and linked to processing rules to describe business process flow.

The processing rules can define business scenarios for each application implementation. Each rule can be associated with one status set and one event set.

Every business object life cycle can be described by a state diagram. The present method uses an Extensible Markup Language (XML) Schema file (XSD) to describe a business life cycle of a business object. Several implementation application programming interfaces (APIs) can be interfaced to describe a business state for every stage in the life cycle.

The invention can be implemented to realize one or more of the following advantages.

A description language using extensible markup language (XML) is used to describe a state diagram representing a life cycle of a business object.

A methodology applies to any business object in many applications. Aplications can apply the implementation without complex infrastructure adoption.

The implementation is based on runtime configuration and not enables a programmer to bypass hard coding a state or activity at design time.

The implementation enables customized business object state diagrams at a customer site due to a runtime loading feature.

One implementation of the invention provides all of the above advantages.

Other features and advantages of the invention are apparent from the following description, and from the claims.

### BRIEF DESCRIPTION OF THE DRAWINGS

FIG. 1 is a block diagram.

FIG. 2 is a block diagram.

FIG. 3 is a block diagram.

FIG. 4 is an exemplary state diagram.

Like reference numbers and designations in the various drawings indicate like elements.

### DETAILED DESCRIPTION

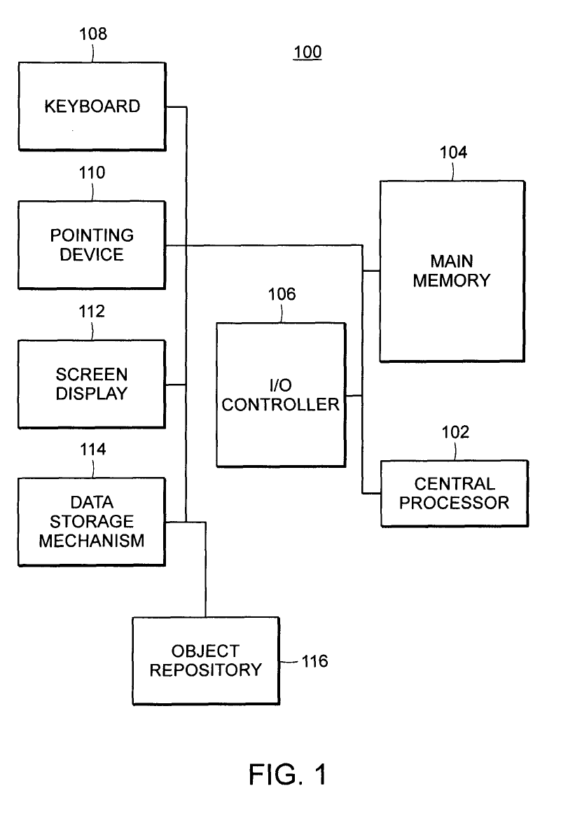

As shown in FIG. 1, an exemplary computer system 100 includes a central processor 102, main memory 104, input/output controller 106, keyboard 108, pointing device 110, screen display 112, data storage mechanism 114, and object repository 116. Object repository 116 may be any one of a number of commercially available repositories, however, in a preferred embodiment, the Business Object Repository from SAP AG of Walldorf, Germany, is utilized. Data storage mechanism 114 may be any one of a number of database systems such as Microsoft Access, dbase, Oracle, Sybase, and so forth. In one particular example, the system 100 is a SAP R/3 Enterprise Resource Planning system available from SAP AG, Walldorf, Germany.

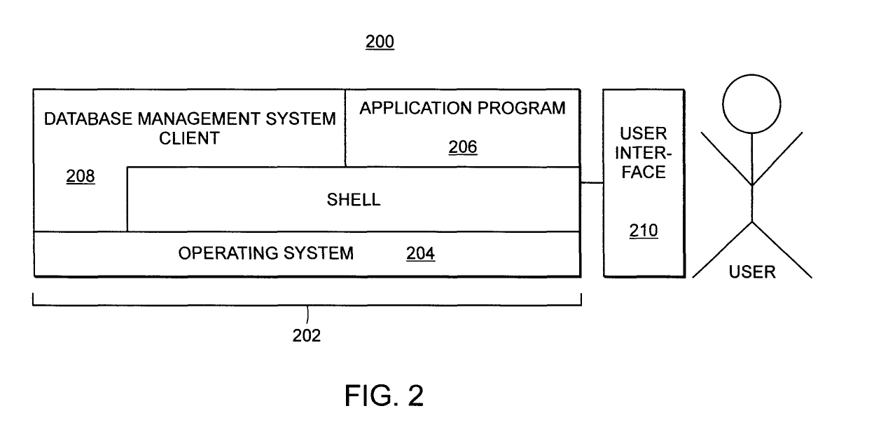

As shown in FIG. 2, computer software system 200 is provided for directing the operation of the exemplary computer system 100. The software system 200, which is stored in system memory 202, and on mass storage or disk memory, includes a kernel or operating system 204, such Windows, Linux, ABAP, Unix and so forth. One or more application programs 206, such as the application software for the present invention, may be loaded (transferred from disk into main memory) for execution by the system 100. There is a database management system client 208 running in system memory 202. The system also includes user interface 210 for receiving user commands and data as input and displaying result data as output.

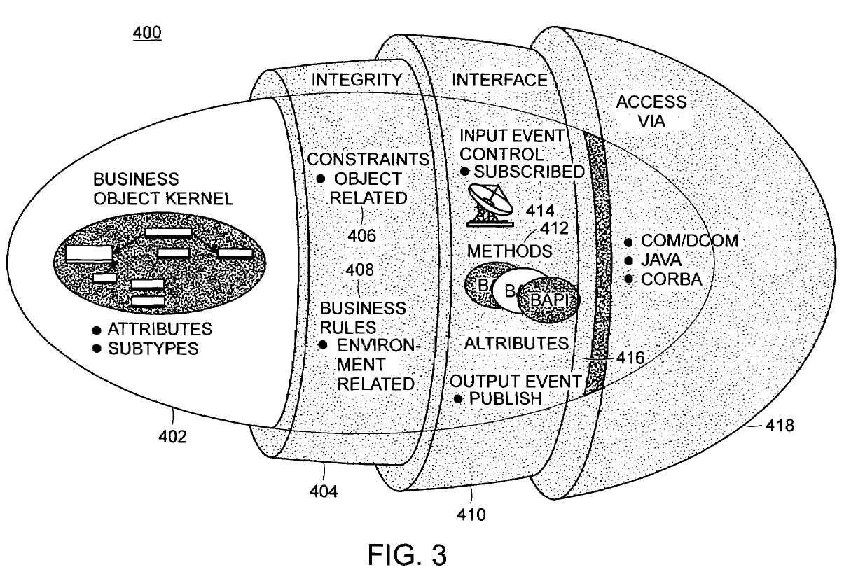

As shown in FIG. 3, an exemplary business object 400 includes business object kernel 402, which contains the core business logic. A second layer 404 contains constraints 406 and business rules 408 (responsible for integrity). The third layer 410 contains methods 412, input event control 414 and output events 416. A final layer 418 is an access layer (COM/DCOM, Java, or CORBA). Business objects of this example implement object-oriented technology such as encapsulation, inheritance, and polymorphism. The third layer 410 is the layer where customized interface reside. Business objects have attributes, which describe the data stored in an object such as “name,” “date of employment,” and “address” of an employee. Attributes of business objects are manipulated by method invocations. The methods of a business object are invoked using a runtime component of a business object Repository (BOR), which maps requests for method calls to the appropriate business object method. Applying the concept of “encapsulation,” data may be accessed in an object-oriented way through the object's methods. BAPI interfaces are specific methods of business objects. An example of a BAPI interface in the context of a sales order “saleorder.getstatus,” which finds out whether an order has been shipped, for example. The set of methods available for a specific object is called the object's interface.

Each business object has a life cycle. From beginning to end, several stages are involved. Each stage is typically described by a “state” and represented by a “status.” Every business object has its unique life cycle and unique states. Even for the same object used in a different company, a life cycle and state may differ. It can be a challenge to manage these object life cycle and states with an application.

Every business object life cycle can be described by a state diagram. In the present invention, an Extensible Markup Language (XML) Schema Defintion (XSD) is used to describe a business life cycle of a business object. An XML schema is a description of a type of XML document, typically expressed in terms of constraints on the structure and content of documents of that type, above and beyond the basic syntax constraints imposed by XML itself. An XML schema provides a view of the document type at a relatively high level of abstraction. An XML Schema instance is an XML Schema Definition (XSD) and typically has the filename extension “.xsd.” The language itself is sometimes informally referenced as XSD.

Several implementation application programming interfaces (APIs) can be interfaced to describe a business state for every stage in the life cycle. For example, when an activity applies to a business object, an API can return a next business state if there is one. Hence, there is no need to “hard code” any “state” transition. In another example, as an activity is about to apply to a business object, an API can be called to validate whether the activity is valid or not. In electronic procurement (E-Procurement), the client site can generate a “button” to describe an activity. Whether the button is generated or not is totally based on the state of the business instance.

E-procurement refers to the business-to-business purchase and sale of supplies and services through the Internet as well as other information and networking systems, such as electronic data interchange (EDI) and Enterprise Resource Planning (ERP).

An API is a source code interface that a computer system or program library provides in order to support requests for services to be made of it by a computer program. The software that provides the functionality described by an API is said to be an implementation of the API. The API itself is abstract, in that it specifies an interface and does not get involved with implementation details.

Using XSD to describe a business life cycle of a business object enables management of the life cycle and enables numerous applications to apply this concept. Software developers do not need to be concerned about the state of the business object, do not need to care about what the next state will be and do not need to “hard code” whether an “activity” is applied.

In another example, combining XSD to describe a business object life cycle with an SAP Java Web Dynpro User Interface (UI) button event, a developer developer does not knowledge about an object life cycle at design time. This also enables a customer to customize activity/state for any given business object and enhance the flexibility of an application.

The following terms are useful in the context of a business object life cycle:

A “status” describes a business object state. Certain activities can be associated with the state. Activity is related to “event.”

A “status set” is a collection of statuses. The status set can be linked to processing rules to describe business process flow.

An “event” is a distinct business activity applied to a business object. Many activities can occur to a business object but only meaningful objects are tracked or or distinct objects made to become events.

An “event set” is a collection of events. The event set can be linked to processing rules to describe business process flow.

A “dependent object” defines whether an activity can be performed or not based on other business object status.

A “process rule” defines a rule for business scenarios for each application implementation. Each rule is associated with one status set and one event set. After the status and event sets are chosen, rules are defined.

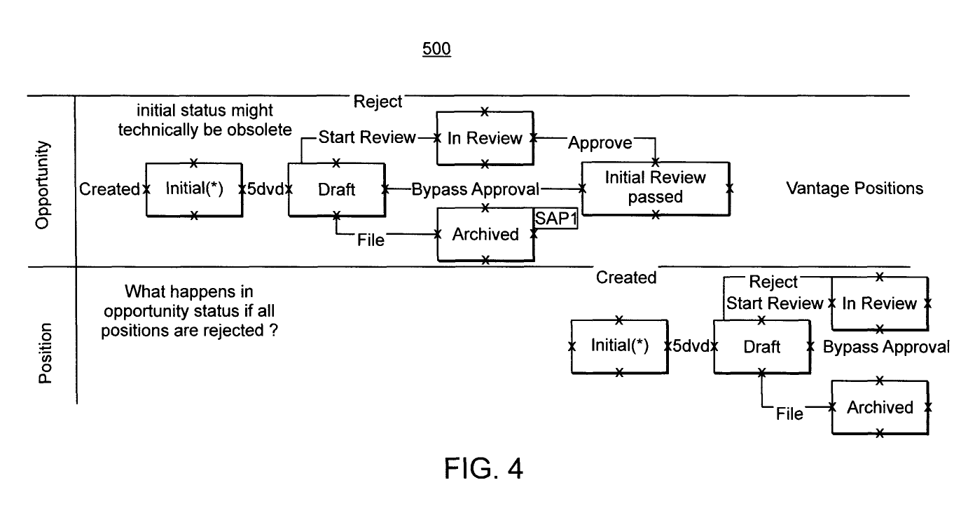

As shown in FIG. 4, an exemplary state diagram 500 includes two business objects 502, 504 described as “opportunity” and “position.” The state diagram 500 describes a life cycle of the business objects 502, 504. When an opportunity is created, the state is in “initial” status. After it is “Save,” the state becomes a “Draft” status. At this moment, either “File” activity or “Start Review” activity can be applied to this opportunity. When the activity “Start Review” is performed, the state becomes in “In Review” status. When an opportunity is in “In Review” status, the reviewer can only “Approve” it or “Reject” it. If the reviewer “Approve” it, the opportunity will be in “Initial Review Passed” state. However, the opportunity becomes a “Draft” status if the reviewer “Reject” the opportunity.

The position business object has its own life cycle. In this particular example, the position business object can only be “Create” if the opportunity is in “Initial Review Passed,” which means that no position is created if the opportunity has not been passed “Review.” After the position is created, it will go through its own life cycle as described in the state diagram 500.

Each business object life cycle can be described using the state diagram 500. Almost every business object has its own life cycle and the same business object life cycle is different in a different companies.

A schema definition for the state diagram 500 is as follows.

```
<?xml version=“1.0” encoding=‘UTF-8’ ?>
<xs:schema xmlns:xs=“http://www.w3.org/2001/XMLSchema”>
<xs:complexType name=“StatusType”>
  <xs:sequence>
    <xs:element name=“Name” type=“ValidStatusSetType” />
    <xs:element name=“MapTo” type=“PDCEValidStatusSetType” />
  </xs:sequence>
</xs:complexType>
<xs:complexType name=“StatusSetType”>
  <xs:sequence>
    <xs:element name=“status” type=“StatusType” maxOccurs=“unbounded”/>
  </xs:sequence>
  <xs:attribute name=“InitialStatus” type=“ValidStatusSetType”/>
</xs:complexType>
<xs:complexType name=“EventSetType”>
  <xs:sequence>
    <xs:element name=“event” type=“ValidEventSetType” maxOccurs=“unbounded”/>
  </xs:sequence>
</xs:complexType>
<xs:simpleType name=“ValidStatusSetType”>
  <xs:restriction base=“xs:string”>
    <xs:enumeration value=“init”/>
    <xs:enumeration value=“created”/>
    <xs:enumeration value=“inprogress”/>
    <xs:enumeration value=“deleted”/>
    <xs:enumeration value=“rejected”/>
    <xs:enumeration value=“opened”/>
    <xs:enumeration value=“freezed”/>
    <xs:enumeration value=“final”/>
    <xs:enumeration value=“closed”/>
    <xs:enumeration value=“submitted”/>
  </xs:restriction>
</xs:simpleType>
<xs:simpleType name=“PDCEValidStatusSetType”>
  <xs:restriction base=“xs:string”>
    <xs:enumeration value=“1INPROCESS”/>
    <xs:enumeration value=“1REVIEW”/>
    <xs:enumeration value=“1ONHOLD”/>
    <xs:enumeration value=“1SOURCING”/>
    <xs:enumeration value=“1INPRICING”/>
    <xs:enumeration value=“1FORREVIEW”/>
    <xs:enumeration value=“1RELEASE”/>
    <xs:enumeration value=“0ARCHABLE”/>
  </xs:restriction>
</xs:simpleType>
<xs:simpleType name=“ValidEventSetType”>
  <xs:restriction base=“xs:string”>
    <xs:enumeration value=“reject”/>
    <xs:enumeration value=“edit”/>
    <xs:enumeration value=“delete”/>
    <xs:enumeration value=“approve”/>
    <xs:enumeration value=“create”/>
    <xs:enumeration value=“close”/>
    <xs:enumeration value=“assignQTL”/>
    <xs:enumeration value=“assignQTM”/>
    <xs:enumeration value=“upload”/>
    <xs:enumeration value=“sanitycheck”/>
    <xs:enumeration value=“signoff”/>
    <xs:enumeration value=“finalize”/>
    <xs:enumeration value=“submit”/>
  </xs:restriction>
</xs:simpleType>
<xs:simpleType name=“ValidObjectName”>
  <xs:restriction base=“xs:string”>
    <xs:enumeration value=“1PROJECT”/>
    <xs:enumeration value=“QProduct”/>
  </xs:restriction>
</xs:simpleType>
<xs:complexType name=“ObjectDependencyType”>
  <xs:sequence>
    <xs:element name=“Name” type=“ValidObjectName” />
    <xs:element name=“Status” type=“ValidStatusSetType” />
  </xs:sequence>
</xs:complexType>
<xs:complexType name=“ProcessRuleType”>
  <xs:sequence>
    <xs:element name=“EventDefinition” type=“EventDefinitionType” maxOccurs=“unbounded”/>
  </xs:sequence>
  <xs:attribute name=“desc” type=“xs:string”/>
</xs:complexType>
<xs:complexType name=“EventDefinitionType”>
  <xs:sequence>
    <xs:element name=“ValidFor” type=“ValidStatusSetType”/>
    <xs:element name=“ObjectDependency” type=“ObjectDependencyType” maxOccurs=“1” minOccurs=“0”/>
    <xs:element name=“StatusTo” type=“ValidStatusSetType”/>
  </xs:sequence>
  <xs:attribute name=“name” type=“ValidEventSetType”/>
</xs:complexType>
<xs:complexType name=“ObjectStatusRuleType”>
  <xs:sequence>
    <xs:element name=“StatusSet” type=“StatusSetType”/>
    <xs:element name=“EventSet” type=“EventSetType”/>
    <xs:element name=“ProcessRule” type=“ProcessRuleType”/>
  </xs:sequence>
  <xs:attribute name=“ObjectName” type=“ValidObjectName”/>
</xs:complexType>
<xs:complexType name=“ObjectStatusRules”>
  <xs:sequence>
    <xs:element name=“ObjectStatusRule” type=“ObjectStatusRuleType” maxOccurs=“unbounded”/>
  </xs:sequence>
</xs:complexType>
<xs:element name=“Node” type=“ObjectStatusRules”/>
</xs:schema>
Here is the XML content for the process rule definition.
<?xml version=“1.0” encoding=“UTF-8”?>
<?xml version=“1.0” encoding=“UTF-8”?>
<Node>
  <ObjectStatusRule ObjectName=“1PROJECT”>
      <StatusSet InitialStatus=“Initial”>
            <status>
                  <Name>Initial</Name>
                  <MapTo>INPROGRESS</MapTo>
            </status>
            <status>
                  <Name>Draft</Name>
                  <MapTo>INPROGRESS</MapTo>
            </status>
            <status>
                  <Name>InReview</Name>
                  <MapTo>INPROGRESS</MapTo>
            </status>
            <status>
                  <Name>InReviewPassed</Name>
                  <MapTo>INPROGRESS</MapTo>
            </status>
            <status>
                  <Name>Pursued</Name>
                  <MapTo>INCOSTING</MapTo>
            </status>
            <status>
                  <Name>Archived</Name>
                  <MapTo>ARCHIVE</MapTo>
            </status>
            <status>
                  <Name>Completed</Name>
                  <MapTo>COMPLETE</MapTo>
            </status>
      </StatusSet>
      <EventSet>
      <event>CreateOpp</event>
      <event>SaveOppDraft</event>
      <event>File</event>
      <event>Pursue</event>
      <event>StartReview</event>
      <event>Reject</event>
      <event>Approve</event>
      <event>Complete</event>
      </EventSet>
      <ProcessRule desc=“Processing Rule for PROJECT”>
            <EventDefinition name=“CreateOpp”>
                  <ValidFor>Initial</ValidFor>
                  <StatusTo>Draft</StatusTo>
            </EventDefinition>
            <EventDefinition name=“SaveOppDraft”>
                  <ValidFor>Init</ValidFor>
                  <StatusTo>Draft</StatusTo>
            </EventDefinition>
            <EventDefinition name=“SaveOppDraft”>
                  <ValidFor>Draft</ValidFor>
                  <StatusTo>Draft</StatusTo>
            </EventDefinition>
            <EventDefinition name=“StartReview”>
                  <ValidFor>Draft</ValidFor>
                  <StatusTo>InReview</StatusTo>
            </EventDefinition>
            <EventDefinition name=“Approve”>
                  <ValidFor>InReview</ValidFor>
                  <StatusTo>InReviewPassed</StatusTo>
            </EventDefinition>
            <EventDefinition name=“Reject”>
                  <ValidFor>InReview</ValidFor>
                  <StatusTo>Draft</StatusTo>
            </EventDefinition>
            <EventDefinition name=“Pursue”>
                  <ValidFor>InReviewPassed</ValidFor>
                  <StatusTo>Pursued</StatusTo>
            </EventDefinition>
            <EventDefinition name=“File”>
                  <ValidFor>Draft</ValidFor>
                  <StatusTo>Filed</StatusTo>
            </EventDefinition>
            <EventDefinition name=“File”>
                  <ValidFor>Initial</ValidFor>
                  <StatusTo>Filed</StatusTo>
            </EventDefinition>
            <EventDefinition name=“Complete”>
                  <ValidFor>Pursued</ValidFor>
                  <StatusTo>Completed</StatusTo>
            </EventDefinition>
      </ProcessRule>
</ObjectStatusRule>
<ObjectStatusRule ObjectName=“QPRODUCT”>
      <StatusSet InitialStatus=“Initial”>
            <status>
                  <Name>Initial</Name>
                  <MapTo>INPROGRESS</MapTo>
            </status>
            <status>
                  <Name>Draft</Name>
                  <MapTo>INPROGRESS</MapTo>
            </status>
            <status>
                  <Name>InReview</Name>
                  <MapTo>INPROGRESS</MapTo>
            </status>
            <status>
                  <Name>InReviewPassed</Name>
                  <MapTo>INPROGRESS</MapTo>
            </status>
            <status>
                  <Name>Pursued</Name>
                  <MapTo>INCOSTING</MapTo>
            </status>
            <status>
                  <Name>Archived</Name>
                  <MapTo>ARCHIVE</MapTo>
            </status>
            <status>
                  <Name>Completed</Name>
                  <MapTo>COMPLETE</MapTo>
            </status>
      </StatusSet>
      <EventSet>
            <event>SaveProduct</event>
            <event>File</event>
            <event>Pursue</event>
            <event>StartReview</event>
            <event>Reject</event>
            <event>Approve</event>
            <event>Complete</event>
      </EventSet>
      <ProcessRule desc=“Processing Rule for PRODUCT”>
            <EventDefinition name=“SaveProduct”>
                  <ValidFor>Initial</ValidFor>
                  <ObjectDependency>
                        <Name>PROJECT</Name>
                        <Status>InReviewPassed</Status>
                  </ObjectDependency>
                  <StatusTo>Draft</StatusTo>
            </EventDefinition>
            <EventDefinition name=“StartReview”>
                  <ValidFor>Draft</ValidFor>
                  <StatusTo>InReview</StatusTo>
            </EventDefinition>
            <EventDefinition name=“Approve”>
                  <ValidFor>InReview</ValidFor>
                  <StatusTo>InReviewPassed</StatusTo>
            </EventDefinition>
            <EventDefinition name=“Reject”>
                  <ValidFor>InReview</ValidFor>
                  <StatusTo>Draft</StatusTo>
            </EventDefinition>
            <EventDefinition name=“Pursue”>
                  <ValidFor>InReviewPassed</ValidFor>
                  <StatusTo>Pursued</StatusTo>
            </EventDefinition>
      </ProcessRule>
  </ObjectStatusRule>
</Node>
```

The following services are implemented:

public static String[ ] statusSet(String objectType)

public static String statusMapTo(String objectType, String status)

public static String[ ] eventSet(String objectType)

public static boolean isEventAllowed(String objectType, String currentStatus, String event)

public static String nextStatus(String objectType, String currentStatus, String event)

public static String[ ] validEvents(String objectType, String currentStatus)

public static String initialStatus(String objectType)

public static boolean isStatusToAllowed(String objectType, String fromStatus, String toStatus)

public static boolean hasDependentObject(String objectType, String currentStatus, String event)

public static HashMap getDependentObject(String objectType, String currentStatus, String event)

The function statusSet( ) returns an array of the status for the given object type.

The function statusMapTo( ) returns a map to status for the given object type and status. The function is used for a chance of a different presentation of the status. For example, “Open” status for opportunity may be stored as “INPROGRESS” in the backend PDCE in R/3.

The function eventSet( ) returns an array of the events for the given object type

The function isEventAllowed( ) verifies whether an event (Activity) can be perform when the given business object is in this status.

The function nextStatus( ), when a specific activity is performed, by calling this method, the next status will be returned as a result. In this case, the developer does not need to know what the object status is after an activity is performed.

The function validEvents( ) returns an array of events that are allowed to be performed for a specific object current status.

The function initialStatus( ) returns the initial status when the business object is created.

The function isStatusToAllowed verifies a status transition is allowed form one state to aonther.

The function hasDependentObject verifies whether a dependent object exists for an event to be performed on a state of the business object.

The function getDependentObject fetches a dependent object for an event within a state of the business object.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A computer-implemented method comprising:
generating a state diagram using an Extensible Markup Language Schema Definition (XSD) file to represent a business object life cycle.

2. The computer-implemented method of claim 1 wherein the XSD file represents an XML schema instance.

3. The computer-implemented method of claim 2 wherein the XML schema is a description of a type of XML document expressed in terms of constraints on a structure and content of documents of that type.

4. The computer-implemented method of claim 1 further comprising interfacing implementation application programming interfaces (APIs) to describe a business state for every stage in the life cycle.

5. The computer-implemented method of claim 1 wherein the life cycle comprises:
a status describing a business object state;
a status set representing a collection of statuses and linked to processing rules to describe business process flow;
an event representing a distinct business activity applied to a business object; and
an event set representing a collection of events and linked to processing rules to describe business process flow.

6. The computer-implemented method of claim 5 wherein the processing rules define business scenarios for each application implementation.

7. The computer-implemented method of claim 6 wherein each rule is associated with one status set and one event set.

8. A computer-readable medium having stored thereupon a plurality of instructions, said plurality of instructions including instructions which, when executed by a processor, cause the processor to perform the step of:
generating a state diagram using an Extensible Markup Language Schema Definition (XSD) file to represent a business object life cycle.

9. The computer-readable medium of claim 8 wherein the XSD file represents an XML schema instance.

10. The computer-readable medium of claim 9 wherein the XML schema is a description of a type of XML document expressed in terms of constraints on a structure and content of documents of that type.

11. The computer-readable medium of claim 8 further comprising an instruction to cause the processor to perform the step of:
interfacing implementation application programming interfaces (APIs) to describe a business state for every stage in the life cycle.

12. The computer-readable medium of claim 8 wherein the life cycle comprises:
a status describing a business object state;
a status set representing a collection of statuses and linked to processing rules to describe business process flow;
an event representing a distinct business activity applied to a business object; and
an event set representing a collection of events and linked to processing rules to describe business process flow.

13. The computer-readable medium of claim 12 wherein the processing rules define business scenarios for each application implementation.

14. The computer-readable medium of claim 12 wherein each rule is associated with one status set and one event set.
